(19) United States
(12) Patent Application Publication
(10) Pub. No.: US 2012/0177546 A1
(43) Pub. Date: Jul. 12, 2012

(54) GAS CONCENTRATION ARRANGEMENT

(75) Inventor: Rainer Hilbig, Aachen (DE)

(73) Assignee: KONINKLIJKE PHILIPS ELECTRONICS N.V., EINDHOVEN (NL)

(21) Appl. No.: 13/387,511

(22) PCT Filed: Sep. 23, 2010
(86) PCT No.: PCT/IB10/54289

§ 371 Date: Jan. 27, 2012

(30) Foreign Application Priority Data
Sep. 30, 2009 (EP) 09171845.2

(51) Int. Cl. B01J 7/00; F04B 41/00

(52) U.S. Cl. 422/305; 91/418

(57) ABSTRACT

The invention relates to the field of increasing the amount of a gas component in a gas mixture, especially of enriching air with oxygen. According to the invention, the gas concentration arrangement comprises: a discharge chamber (1) including an input side and an output side, —a gas discharge device (2) for generating a gas discharge inside the discharge chamber (1) for generating a pressure gradient on the output side and/or the input side of the discharge chamber (1), and a gas selection device (3), which is arranged on the input side or the output side of the chamber (1) and which is exposable to a gas flow generated by the pressure gradient.

### FIELD OF THE INVENTION

The invention relates to the field of increasing the amount of a gas component in a gas mixture, especially of enriching air with oxygen.

### BACKGROUND OF THE INVENTION

Oxygen therapy is the administration of Oxygen as a therapeutic modality. Oxygen therapy benefits the patient by increasing the supply of Oxygen to the lungs and thereby increasing the availability of Oxygen to the body tissues. The main homecare application of Oxygen therapy is for patients with severe chronic obstructive pulmonary disease (COPD), a disease that affects more than 13 million patients in the US.

For on-demand generation of Oxygen, commercial solutions, so-called Oxygen concentrators, have been developed in the past. WO98/56488 discloses an oxygen concentrator, which has a first molecular sieve bed connected to a four-way valve, which either joins the sieve bed to a pressurized air source or alternatively vents it to atmosphere. A second molecular sieve bed is also joined to the four-way valve in a corresponding manner. The first and the second molecular sieve bed adsorb gas components like nitrogen, carbon monoxide, carbon dioxide and water vapor. One bed is joined to the compressed air to produce oxygen-enriched air while the other is vented to atmosphere to cause evacuation. The sieve beds are joined at the outlet end to a product reservoir. The oxygen-enriched product gas passes from the reservoir to the patient. For providing a pressurized air, the oxygen concentrator comprises a compressor unit.

Traditional Oxygen concentrators are bulky, heavy, and require ongoing maintenance by patients and homecare providers. Due to the compressor unit, such devices produce noise and heat. Furthermore, a reduction of cost price (a compressor unit comes up with a significant contribution), of recurrent purchase costs and of servicing is desirable.

### SUMMARY OF THE INVENTION

It is an object of the invention to provide a gas concentration arrangement, a gas concentration system and a gas pump, which are cost-saving, can be operated at low noise and are easy to maintain.

According to the invention the gas arrangement comprises:

a discharge chamber including an input side and an output side,

a gas discharge device for generating a gas discharge inside the discharge chamber for generating a pressure gradient on the output side and/or the input side of the discharge chamber, and

a gas selection device, which is arranged on the input side or the output side of the chamber and which is exposable to a gas flow generated by the pressure gradient.

The gas concentration arrangement according to the invention comprises a gas discharge device for generating pressurized gas by generating a plasma. A pressure in the discharge chamber can be increased during high power-operation of the plasma, and the pressure can be decreased during low power operation or turning off the plasma. A pressure swing can be obtained by running a power-modulated discharge in the discharge chamber.

Generating pressurized gas by a discharge device in a discharge chamber has advantages with respect to cost price, servicing and noise. A further advantage is that the pressurized air is intrinsically disinfected and sterilized.

The gas selection device selects one or more gas components of a gas mixture, preferably air, for example by adsorption or by absorption of this one or more gas components. Such gas components are hindered by the gas selection device to flow through. Therefore, the gas mixture, which flows through the gas selection device, is enriched with those one or more gas components, which may easily flow through the gas selection device.

In a preferred embodiment, the gas selection device is nitrogen selective and oxygen non-selective. In this case, the gas mixture, which exits the gas selection device, is enriched with oxygen.

In a preferred embodiment, the gas selection device comprises at least one selective molecular sieve and/or one selective membrane. Preferred materials, which can be used for a molecular sieve or a selective membrane, are zeolite, carbon or polyamid. These materials select gas components mainly by adsorption.

In a preferred embodiment, the gas discharge device comprises a coupling device to generate a gas discharge by capacitive, inductive, surface wave and/or microwave coupling.

It is preferred, that the coupling device is arranged outside the gas discharge chamber. The wearing down of parts of the coupling device, especially of electrodes, can be significantly reduced. However, it is also possible to arrange parts of the coupling device at least partially inside the discharge chamber.

In a preferred embodiment, the gas concentration arrangement comprises, in addition, an inlet valve, which is arranged on the input side of the discharge chamber, and an outlet valve, which is arranged on the output side. By adapting the operation of the inlet valve and the outlet valve to a power modulated gas discharge, a gas flow can be generated with a specific direction. Preferably, the inlet valve and the outlet valve are operated cyclic and phase shifted, for example, in an anti-parallel manner.

In a preferred embodiment, the gas concentration arrangement comprises, in addition, a gas reservoir, which is arranged on the output side or on the input side of the discharge chamber. Even if operating the gas discharge device with a power-modulated discharge, a nearly constant over pressure or under pressure can be generated in the reservoir, which can be used for producing a continuous gas flow, preferably by using a valve or an orifice on an outlet or an inlet of the reservoir.

In a preferred embodiment, the gas concentration arrangement comprises, in addition, an exhaust gas outlet device to blow of exhaust gas generated by the gas selection device.

In a preferred embodiment, the discharge chamber comprises a gas inlet, a first gas outlet and a second gas outlet, wherein the gas outlet device is connected to the first gas outlet and the gas discharge device is connected to the second gas outlet. This allows for a compact design of the gas concentration arrangement.

The gas concentration system according to the invention comprises at least two inventive gas concentration arrangements, wherein the two arrangements are joined on their output side.

Such a gas concentration system is able to provide a nearly continuous gas flow by operating a first arrangement and a second arrangement phase shifted, especially in an antiparallel manner.

The gas pump according to the invention comprises a discharge chamber including an input side and an output side, a gas discharge device for generating a gas discharge inside the discharge chamber for generating a pressure gradient on the output side and/or the input side of the discharge chamber, and an inlet valve, which is arranged on the input side of the discharge chamber, and an outlet valve, which is arranged on the output side.

### BRIEF DESCRIPTION OF THE DRAWINGS

These and other aspects of the invention will be apparent from and elucidated with reference to the embodiments described hereinafter.

In the drawings:

FIG. 1 is a schematic view of a first embodiment of a gas concentration arrangement in a state of generating a gas flow through the gas selection device by use of a high-power plasma;

FIG. 2 is a schematic view of the first embodiment of a gas concentration arrangement in a state of outgassing of the gas selection device;

FIG. 3 is a schematic view of the first embodiment of a gas concentration arrangement in a state of filling the discharge chamber with fresh gas;

FIG. 4 is a schematic view of a second embodiment of a gas concentration arrangement;

FIG. 5 is a schematic view of a third embodiment of a gas concentration arrangement;

FIG. 6 is a schematic view of a fourth embodiment of a gas concentration arrangement;

FIG. 7 is another schematic view of the first embodiment of a gas concentration arrangement;

FIG. 8 is a schematic view of a fifth embodiment of a gas concentration system;

FIG. 9 is a schematic view of a sixth embodiment of a gas concentration arrangement;

FIG. 10 is a diagram displaying a rms-current in dependence of time;

### DETAILED DESCRIPTION OF EMBODIMENTS

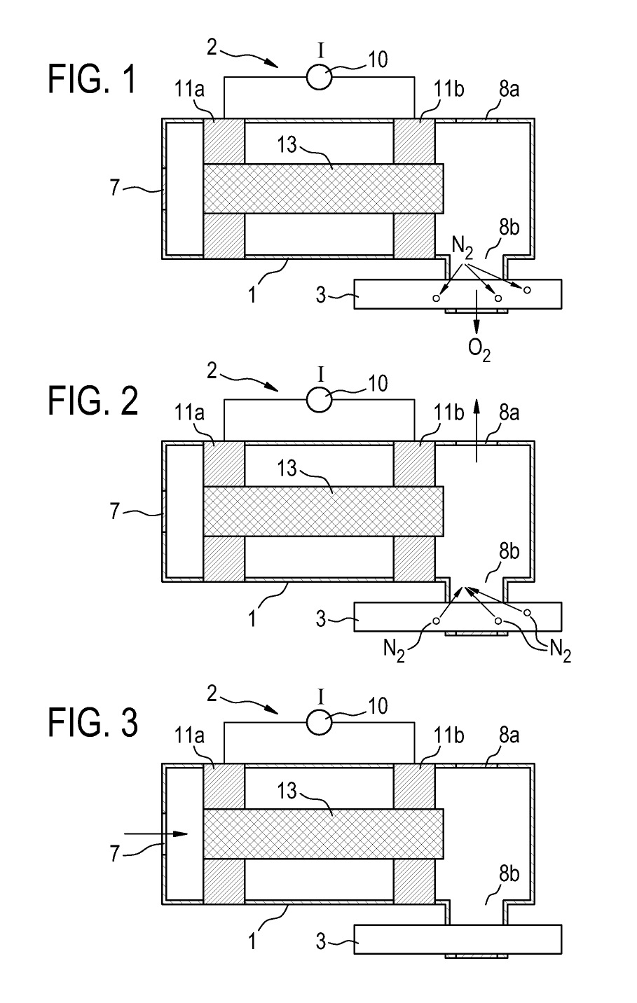

FIGS. 1 to 3 display a first embodiment of a gas concentration arrangement according to the invention. This first embodiment is also displayed in FIG. 7.

The gas concentration arrangement according to the first embodiment comprises a discharge chamber 1 including an input side and an output side, a gas discharge device 2 for generating a gas discharge inside the discharge chamber 1 for generating a pressure gradient on the output side of the discharge chamber 1, and a gas selection device 3, which is arranged on the output side of the chamber 1 and which is exposable to a gas flow generated by the pressure gradient. The “input side” of the discharge chamber 1 is the side of the discharge chamber 1 from which gas flows into the chamber 1, the “output side” of the discharge chamber 1 is the side of the discharge chamber 1, where gas flows out of the discharge chamber 1.

The gas discharge device comprises a coupling device to generate a gas discharge by capacitive, inductive, surface wave and/or microwave coupling, and an energy source 10 to provide the coupling device with an alternating current. In this embodiment, the coupling device comprises two electrodes 11a, 11b, which are arranged outside the gas discharge chamber 1 for capacitive coupling. By means of the energy source 10, a voltage could be applied between the two electrodes 11a, 11b, leading to a gas discharge and to the generation of a plasma 13 inside the discharge chamber 1. An alternating current allows to sustain the plasma 13 over time, by changing of the amplitude of the alternating current the power of the plasma 13 can be modulated.

The discharge chamber 1 comprises a gas inlet 7, a first gas outlet 8a and a second gas outlet 8b. Connected to the first gas outlet 8a is a gas outlet device 4 to blow of exhaust gas generated by the gas selection device 3, see FIG. 7. For example, the outlet device 4 can be a simple two way valve, which is on one side connected to the discharge chamber 1 and on the other side connected to the atmosphere 12 or a reservoir for exhaust gas. The gas discharge device 2 is connected to the second gas outlet 8b. To control gas flow through the gas inlet 7 and the second gas outlet 8, an inlet valve 5 is connected with the gas inlet 7 and an outlet valve 6 is connected with the second gas outlet 8b, wherein the gas selection device 3 is arranged between the second gas outlet 8b and the outlet valve 6. As inlet valve 5 and outlet valve 6, non-return valves or two-way valves can be used, for example. Non-return valves are preferred because they do not need controlling.

The gas selection device 3 comprises at least one selective molecular sieve and/or one selective membrane, which is nitrogen selective and oxygen non-selective. Preferably, the molecular sieve or the membrane comprises zeolite. Zeolite adsorbs nitrogen, carbon, carbon monoxide, carbon dioxide, water vapor and other significant components of air, but is non-selective for oxygen.

In the following, the operation of the gas concentration arrangement will be described.

In a first step (compression and oxygen diffusion), starting at the pressure of 1 bar and with closed exhaust device 4 and inlet valve 5, air in the discharge chamber 1 is compressed due to generating and sustaining a high-power plasma 13 inside the discharge chamber 1, see FIG. 1. The plasma leads to an increase in gas temperature, which results in an increased pressure due to the fact that the discharge chamber 1 is closed against the surrounding air. The air inside the chamber 1, especially oxygen and nitrogen, can only leave the chamber 1 by diffusing through the gas selection device 3 (O₂) or diffusing into the gas selection device 3 by adsorption (N₂). The oxygen enriched air flows through the outlet valve 6. The oxygen enriched air can be passed to a patient or stored in a reservoir.

After a certain time interval, in a second step, the gas exhaust device 4 is opened to the surrounding air and the outlet valve 6 closes or is closed, see FIG. 2. During this phase the pressure in the discharge chamber 1 goes down to atmospheric pressure. The plasma 13 is kept at high power for significantly reducing the particle density. Therefore, nitrogen that is adsorbed in the gas selection device 3 diffuses out of the gas selection device 3 through the discharge chamber 1 and through the gas exhaust device 4 towards the atmosphere 12.

After a further time interval, in a third step, see FIG. 3, the discharge power is reduced significantly or switched off, the gas exhaust device 4 is closed, the outlet valve 6 closes or is closed and the inlet valve 5 opens or is opened. The gas temperature with it the pressure inside the discharge chamber 1 drops. Fresh air flows into the discharge chamber 1 through the gas inlet 7.

After a further time interval, the cycle is finished. For continuing, the power-modulated gas discharge device 2 starts again with the first step. If the plasma 13 has been not switched off, igniting the plasma in the following step can be omitted.

The gas concentration arrangement can be operated without an overlapping of the first, the second and the third step. Alternatively, the gas concentration arrangement can be operated with one or more steps overlapping.

In this embodiment, the discharge chamber 1, the discharge device 2, the inlet valve 5 and the outlet valve 6 function as a gas pump, producing a directed flow of gas.

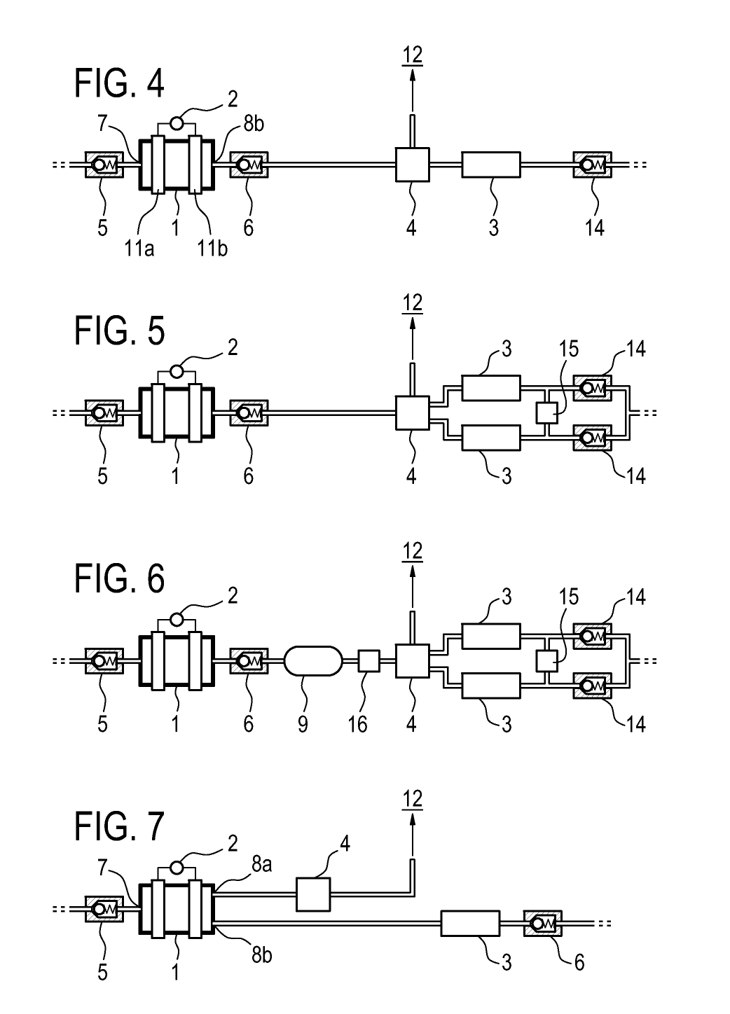

FIG. 4 displays a second embodiment of a gas concentration arrangement.

The gas concentration arrangement according to the second embodiment comprises an inlet valve 5, a gas discharge chamber 1, a gas discharge device 2, an outlet valve 6, a gas exhaust device 4, a gas selection device 3 and a third valve 14, which are connected to each other in the order as stated. The third valve 14 is, for example, a two-way valve or, preferably, a non-return valve.

In this embodiment, the discharge chamber 1 is a glass sphere, for example a hard glass, with an inner diameter of 4 cm, the electrodes 11a, 11b of the discharge device 2 are inner carbon rod electrodes, for example with an electrode diameter of 4 mm and an electrode distance of <10 mm. The discharge chamber 1 has two glass pipes (not shown) as gas inlet 7 and as gas outlet 8a. In contrast to the first embodiment, a second gas outlet 8a is not provided. At the gas inlet 7 and at the outlet 8b non-return valves 5, 6 are mounted. Due to these non-return valves 5, 6, gas can flow only from the inlet 7 to the outlet 8b. Gas flow measurements have been performed by putting suited flow meters into the inlet and outlet pipes in front or behind of the non-return valves 5, 6.

The carbon electrodes are connected to an energy source 10 that delivers a square wave current I at 300 Hz frequency with variable output power, i.e. the root mean square(rms) value of the current Iₘₑₐₙ at 300 Hz driving frequency can be varied on a time scale above t=50 ms. Currents Iₘₑₐₙ up to several amperes and powers of several hundred watts are feasible with the electronic driver. The energy source 10 also delivers peak voltages of up to 20 kV for start phase to obtain a gas breakdown/igniting the plasma 13.

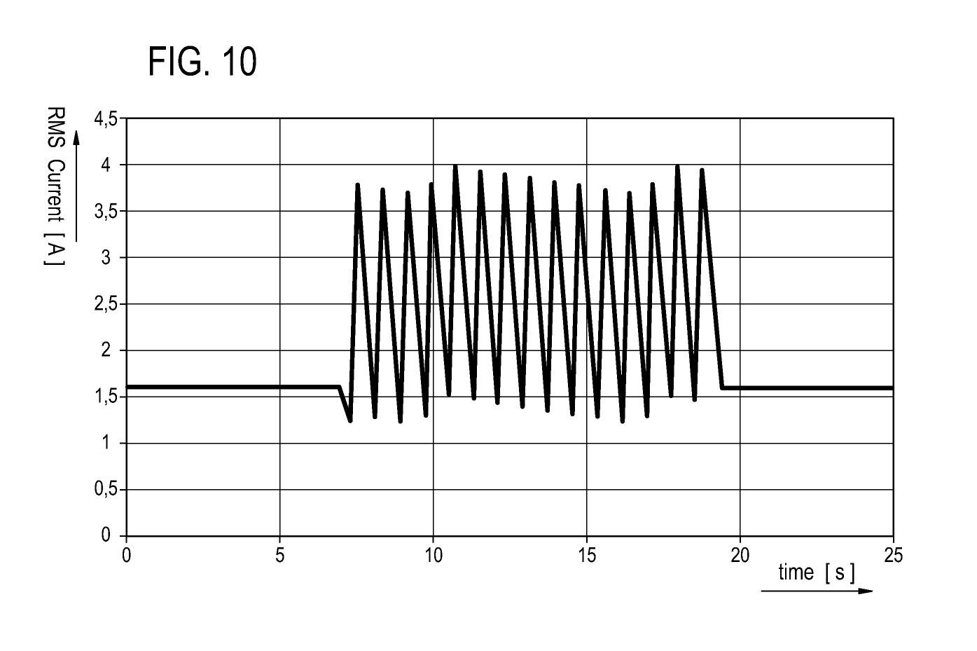

For testing the second embodiment a current waveform Iₘₑₐₙ was chosen as shown in FIG. 10. After applying a 20 kV pulse to the electrodes 11a, 11b for achieving gas breakdown between the electrodes inside of the discharge chamber 1, the gas discharge in air was operated at Iₘₑₐₙ=1.6 A for about 7 s to stabilize the system. Then, Iₘₑₐₙ was modulated for about 12 s between Iₘₑₐₙ=1.2 A and Iₘₑₐₙ=4 A as shown in FIG. 5. Afterwards, current was set to Iₘₑₐₙ=1.6 A again for comparison purposes.

Significant air flux was observed in the interval during which the gas discharge device was operated at modulated current (power), i.e. for t=7-12 s, see FIG. 10. Before that period and afterwards (t=0 s-7 s and t=20 s-25 s), those time intervals during which Iₘₑₐₙ=1.6 A=constant, no significant air flux at the air outlet was detectable. In the phase of modulated current, a flux Fₐᵢᵣ (average over the modulation time) of Fₐᵢᵣ=5 l/h against surrounding pressure and of Fₐᵢᵣ=1.2 l/h against an overpressure of 70 mbar was measured after the outlet valve 6.

For enriching air with oxygen, the arrangement according to the second embodiment can be operated in the following manner.

In a first step, fresh air is pumped by modulated gas discharge inside the chamber 1 from the surroundings or an reservoir through the inlet valve 5, the discharge chamber 1 and the outlet valve 6, the gas exhaust device 4 and the gas selection device 3, leading to a flow of oxygen enriched air passing the open valve 14. In this step, the gas exhaust device 4, which is, for example, a three-way valve, is closed to the surrounding air 12.

In a second step, the gas exhaust device 4 opens a connection between the gas selection device 3 and the surrounding air 12 and closes the connection to the outlet valve 6. After outgassing of the gas selection device 3, which can be supported by a purge gas (not shown), the cycle can continue with the first step.

FIG. 5 displays a third embodiment of a gas concentration arrangement.

In addition to the second embodiment, the third embodiment comprises a second gas selection device 3, a further third valve 14 and a fourth valve 15, wherein the second gas selection device 3 and the further third valve 14 are connected to the exhaust gas device 4 parallel to the first gas selection device 3 and valve 14. Between the gas selection devices 3 and the third valves 14, the fourth valve 15 is connected parallel to these two lines. After the third valves 14, both lines are joined. Alternatively, fourth valve 15 could be substituted by an orifice.

The arrangement can be operated in the following manner.

In a first step, fresh air is pumped by modulated gas discharge inside the chamber 1 from the surroundings or an reservoir through the inlet valve 5, the discharge chamber 1, the outlet valve 6 and the gas exhaust device 4 to one of the two gas selection devices 3, leading to a flow of oxygen enriched air passing one of the two open valves 14. The other gas selection device 3 is disconnected from outlet valve 6 but connected by gas exhaust device 4 to the surroundings 12.

In a second step, the gas exhaust device 4 closes the connection of the other gas selection device 3 to the surroundings 12 and opens the connection to the outlet valve 6, so that fresh air is pumped through the other gas selection device 3, leading to a flow of oxygen enriched air passing the second open valve 14. Furthermore, the connection between the outlet valve 6 and the first gas selection device 3 is closed by gas exhaust device 4 and the connection to the surroundings 12 is opened, enabling outgassing of the first gas selection device 3.

After outgassing of the gas selection device 3, the cycle can continue with the first step. Due to the fourth valve 15 an amount of the oxygen enriched air can be lead as purge gas through the gas selection device 3, which is connected to the surroundings 12, supporting the outgassing of this gas selection device 3. The third valves 14 are preferably non-return valves, preventing a back flow of oxygen enriched air. As gas exhaust device 4 a four-way valve can be used, for example.

The arrangement according to the third embodiment allows a more continuous producing of oxygen enriched air.

FIG. 6 displays a fourth embodiment of a gas concentration arrangement.

In addition to the third embodiment, the fourth embodiment comprises a gas reservoir 9 and a reservoir-valve 16. Alternatively, the valve 16 can be substituted by an orifice.

The gas reservoir 9 is arranged between the outlet valve 6 and the gas exhaust device 4. By pumping air from the gas discharge chamber 1 inside the gas reservoir 9, an over pressure inside the reservoir 9 can be generated, preferably by increasing the flow resistance after the gas reservoir 9 by using the valve 16 or, alternatively, an orifice. A constant or nearly constant over pressure can be used to produce a continuous or nearly continuous gas flow. By alternating the two gas selection devices 3, a constant or nearly constant oxygen enriched air flow can be generated at the output of the arrangement.

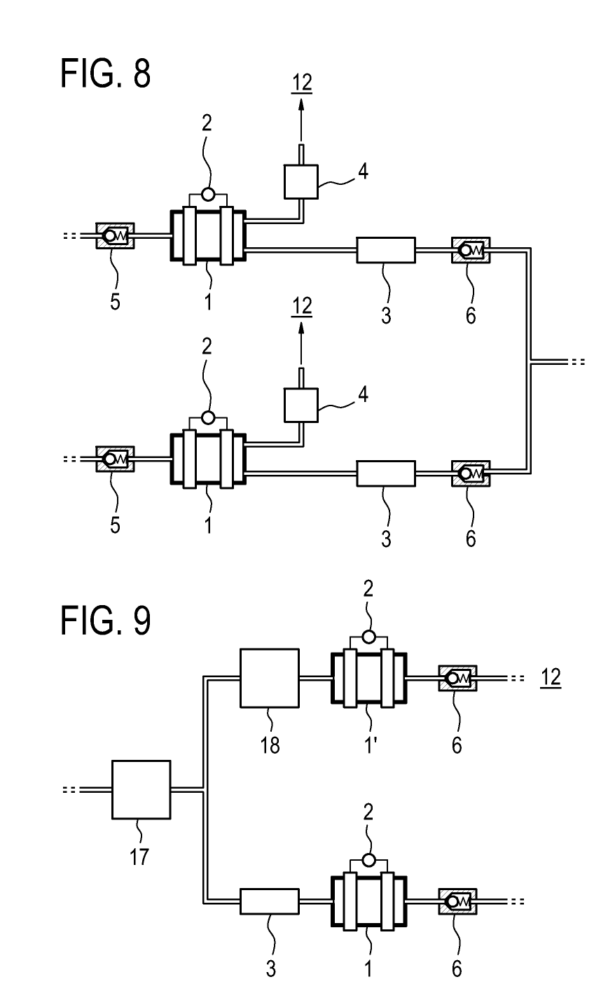

FIG. 8 displays a fifth embodiment of a gas concentration arrangement.

According to the fifth embodiment, two gas concentration arrangements according to the first embodiment are connected in parallel and joined behind their outlet valves 6. By operating the two gas concentration arrangements phase shifted or in an antiparallel manner, a continuous or nearly continuous flow of oxygen enriched air can be generated at the output of the arrangement.

Further gas concentration arrangements could be added in a similar way.

FIG. 9 displays a sixth embodiment of a gas concentration arrangement.

According to the sixth embodiment, the gas concentration arrangement comprises two gas discharge chambers 1 and two gas discharge devices 2, which are arranged in two different lines of the arrangement. The two lines are joined on the input side of the two gas discharge chambers 1 and connected via an inlet valve 17, for example, a two-way valve, to fresh air or a gas reservoir. On the output side, one of the lines is connected via an output valve 6 to the surroundings 12; the other line is connected via an output valve 6 to, for example, a gas reservoir or a patient. As output valves 6 non-return valves or two-way valves are preferred. In the line connected to the surroundings, a valve 18, for example, a two-way valve, is arranged on the input side of the gas discharge chamber 1. In the other line, a gas selection device 3 is provided on the input side of the gas discharge chamber 1.

In this embodiment, by means of the gas discharge devices 2 a pressure gradient can be generated on the input side of each of the discharge chambers 1.

For enriching air with oxygen, the arrangement according to the sixth embodiment can be operated in the following manner.

In a first step, valve 17 is open and valve 18 is closed. Pressure at the output side of the gas selection device 3 is reduced by modulated gas discharge inside the gas discharge chamber 1 being arranged in the same line as the gas selection device 3. Fresh air from the surroundings or an reservoir flows through the open valve 17 to the gas selection device 3, leading to a flow of oxygen enriched air passing the discharge chamber 1 and the open outlet valve 6.

In a second step, valve 17 is closed and valve 18 is opened. Now pressure at the input side of the gas selection device 3 is reduced by modulated gas discharge inside the chamber 1 being arranged in the other line. Especially nitrogen desorbs from the gas selection device 3 and flows through the open valve 18, through the discharge chamber 1 and the open outlet valve 6 into the surrounding air 12. The cycle can now continue with the first step. This principle, according to which the gas selection device is provided on the input side of the discharge chamber 1, can be transferred to the first to fifth embodiments shown in FIGS. 4-8.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage. Any reference signs in the claims should not be construed as limiting the scope.

1. Gas concentration arrangement, comprising:
a discharge chamber including an input side and an output side,
a gas discharge device for generating a gas discharge inside the discharge chamber for generating a pressure gradient on the output side and/or the input side of the discharge chamber, and
a gas selection device, which is arranged on the input side or the output side of the chamber and which is exposable to a gas flow generated by the pressure gradient.

2. Gas concentration arrangement according to claim 1, wherein the gas selection device is nitrogen selective and oxygen non-selective.

3. Gas concentration arrangement according to claim 1, wherein the gas selection device comprises at least one selective molecular sieve and/or one selective membrane.

4. Gas concentration arrangement according to claim 1, wherein the gas discharge device comprises a coupling device to generate a gas discharge by capacitive, inductive, surface wave and/or microwave coupling.

5. Gas concentration arrangement according to claim 1, comprising, in addition, an inlet valve, which is arranged on the input side of the discharge chamber, and an outlet valve, which is arranged on the output side.

6. Gas concentration arrangement according to claim 1, comprising, in addition, a gas reservoir, which is arranged on the output side or on the input side.

7. Gas concentration arrangement according to claim 1, comprising, in addition, an exhaust gas outlet device to blow of exhaust gas generated by the gas selection device.

8. Gas concentration arrangement according to claim 7, wherein the discharge chamber comprises a gas inlet, a first gas outlet and a second gas outlet, wherein the gas outlet device is connected to the first gas outlet and the gas discharge device is connected to the second gas outlet.

9. Gas concentration system, comprising at least two gas concentration arrangements according to claim 1, wherein the two arrangements are joined on their output side.

10. A gas pump for pumping gas, comprising:
a discharge chamber including an input side and an output side,
a gas discharge device for generating a gas discharge inside the discharge chamber for generating a pressure gradient on the output side and/or the input side of the discharge chamber, and
an inlet valve, which is arranged on the input side of the discharge chamber, and
an outlet valve, which is arranged on the output side.
